(19) United States
(12) Patent Application Publication
(10) Pub. No.: US 2010/0299593 A1
(43) Pub. Date: Nov. 25, 2010

(54) APPARATUS AND METHOD FOR PROCESSING A DOCUMENT CONTAINING VARIABLE PART

(75) Inventor: Kazumi Chiba, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/781,176

(22) Filed: May 17, 2010

(30) Foreign Application Priority Data
May 19, 2009 (JP) 2009-121215

(51) Int. Cl. G06F 17/21

(52) U.S. Cl. 715/255

(57) ABSTRACT

A document processing apparatus efficiently corrects contents data improperly selected upon editing a document. The apparatus displays a document, selects content data from the displayed document, based on a user's operation, displays, as deriving process information, a creation rule, personal data and metadata which are referred to in using the selected content data to create the document, and corrects the displayed deriving process information, based on a user's operation.

### BACKGROUND OF THE INVENTION

1. Field of the Invention

The present invention relates to a document processing apparatus for processing a plurality of documents, each of which contains a variable part, and the method for the same.

2. Description of the Related Art

A function ‘variable printing’ is printing a plurality of documents with a different content in a variable part in the document template for each document.

In this document template, the part which is not changed in variable printing is called a Fixed data field, and the above-mentioned variable part is called a Variable data field. One print unit consisting of a Variable data field with text or image data embedded is called one record. The text or image data embedded in the data field is called content data.

If image data is to be embedded in the Variable data field, a creation rule for identifying the image data or the file name of the image data is entered in the Variable data field so that link can be made with the image database. In the circumstances, corresponding image data is pasted on each record for such operations as printing to be performed.

Each record can be identified by, for example, personal data for identifying an individual. The personal data may be an individual's name or sex.

The creation rule set in the Variable data field is a conditional expression using personal data or metadata for extracting the corresponding image data from the image database and pasting the data on the Variable data field. It is assumed that the creation rule ‘IF “sex”=“female” A, else if “sex”=“male” B’ is set in the Variable data field. According to this creation rule, if the sex of the personal data of a record is female, the image data A in the image database is pasted, and if the sex of the personal data of the record is male, the image data B is pasted. While A and B may be the file name of the image data, it is assumed here that metadata or the like is embedded in the image data so that the apparatus search embedded metadata to paste the corresponding data on the document template.

When the document template for the variable printing is created, only the data like the creation rule for identifying the text or image data the editor wants to paste is displayed in the Variable data field of each record, which means that what data is pasted there can be seen only after the print data is created. For that reason, the apparatus for variable printing has a function for displaying the print data whose Variable data field has text or image data pasted, before printing the data. With that function, the editor checks and corrects the print data for each record.

For example, Japanese Patent Application Laid-Open No. 2006-221494 discloses a document editing apparatus capable of displaying input image data on an editing screen for processing the displayed image data through editing setting, and of immediately displaying the edited image data.

In the system for searching corresponding metadata from a database by using personal data, creation rule and metadata, and pasting the acquired content data on the Variable data field, however, the correcting method of Japanese Patent Application Laid-Open No. 2006-221494 is inefficient. Because, if the content data of a plurality of Variable data fields has an error, the above-mentioned method requires the editor to correct the content data independently for each of the Variable data fields.

If a wrong selection is caused by a wrong registration of the personal data, the data in the other data fields, to which the creation rule using the same wrongly registered personal data of the same record is added, is pasted wrongly, too. Therefore, if the data in the Variable data field which is recognized as the wrong selection is directly corrected on the editing screen, the data in the other Variable data fields which is wrongly selected for the same reason still remains uncorrected.

Now, consider the case in which the wrong selection is caused by the wrong registration of metadata which is embedded in the image data stored in the image database. In this case, if the image data is changed on the editing screen, the other Variable data fields using the same image data still remain uncorrected; therefore, the same correction has to be repeated on each of the Variable data fields.

Therefore, it is efficient to correct the error caused data, instead of directly correcting the content data which is wrongly pasted on the Variable data fields. For that purpose, a process in which the data was wrongly selected has to be identified among the deriving processes of the image data which is pasted on the Variable data field. After that, the process identified as the cause of the wrong selection should be properly corrected.

### SUMMARY OF THE INVENTION

An object of the present invention is to enable efficient correction, when wrongly selected content data is found in document edition.

In order to achieve the object, the present invention displays a document created based on a creation rule of a document, personal data for each individual, and content data with metadata added, selects the content data from the displayed document, based on a user's operation, displays, as deriving process information, the creation rule, the personal data and the metadata which are referred to in using the selected content data to create the document, and corrects the displayed deriving process information, based on a user's operation.

Further features of the present invention will become apparent from the following description of exemplary embodiments with reference to the attached drawings.

### BRIEF DESCRIPTION OF THE DRAWINGS

FIG. 1 is a block diagram illustrating an example of hardware configuration of a document processing apparatus.

FIG. 2 is a block diagram illustrating an example of functional configuration of the document processing apparatus.

FIG. 3 is a diagram illustrating an example of personal document.

FIG. 4 is a diagram illustrating an example of deriving processes.

FIG. 5 is a diagram illustrating an example of metadata.

FIG. 6 is a flowchart showing an example of processing concerned with correction of a personal document.

FIG. 7 is a flowchart showing an example of change and highlight processing on deriving processes.

FIG. 8 is a diagram illustrating an example of correction on the deriving processes.

FIG. 9 is a diagram illustrating an example of application of a corrected deriving process.

FIG. 10 is a diagram illustrating an example of a corrected personal document.

FIG. 11 is a diagram illustrating processing when image data other than that for a selected state frame is wrongly pasted for the same reason.

FIG. 12 is a diagram illustrating processing when personal data change is reflected on the other frames.

FIG. 13 is a diagram illustrating an example of creation rule correction.

FIG. 14 is a diagram illustrating an example of application and the like of the corrected creation rule.

FIG. 15 is a diagram illustrating processing when creation rule change is reflected on the other frames.

FIG. 16 is a flowchart illustrating an example of processing concerned with the correction of metadata.

FIG. 17 is a diagram illustrating an example of metadata correction.

### DESCRIPTION OF THE EMBODIMENTS

Preferred embodiments of the present invention will now be described in detail in accordance with the accompanying drawings.

An embodiment will be described below by using an example of creating a yearbook for graduating students of a school as a document template to create a personal album. In the description below, the document template will be used as an example of a Document template.

In the embodiment, for simplicity of the description, image data is pasted on a Variable data field as an example of content data.

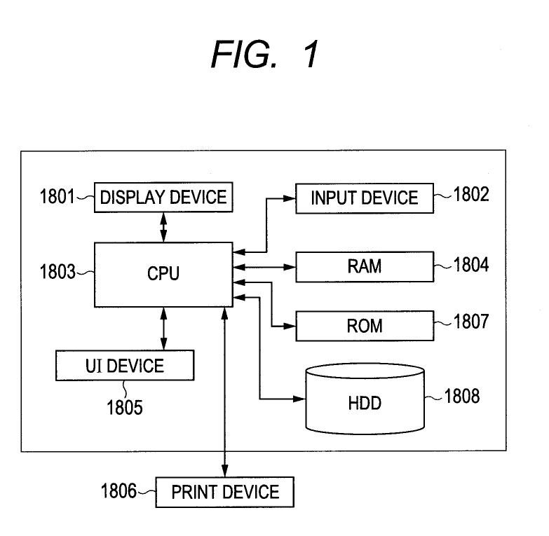

FIG. 1 is a block diagram illustrating an example of hardware configuration of a document processing apparatus, which is an example of Document processing apparatus.

A display device 1801 is a CRT, liquid crystal monitor or the like. An input device 1802 has a pointing device such as a keyboard, mouse or the like. A ROM 1807 stores a program executed by a CPU 1803. A RAM 1804 stores programs and data files loaded from an HDD 1808. The HDD (hard disk drive) 1808 has a hard disk and a drive for reading and writing data to and from the hard disk. In the HDD 1808, document data, personal data, creation rule, programs, and image database to be described later are stored.

A UI (user interface) device 1805 has a touch panel and the like for accepting input from a user.

The functions to be described later or the processing shown in the flowcharts are implemented by the CPU 1803 executing the programs stored in the ROM 1807, the HDD 1808 or the like.

A print device 1806 is capable of transmitting data like documents with a document management device via a network, cable or the like.

The document processing apparatus may be configured to have the print device 1806. That is, the document processing apparatus may be implemented as a multifunctional machine or the like. In this case, the display device 1801 and the input device 1802 are implemented as an operating device or the like which has a touch panel for inputting and displaying information.

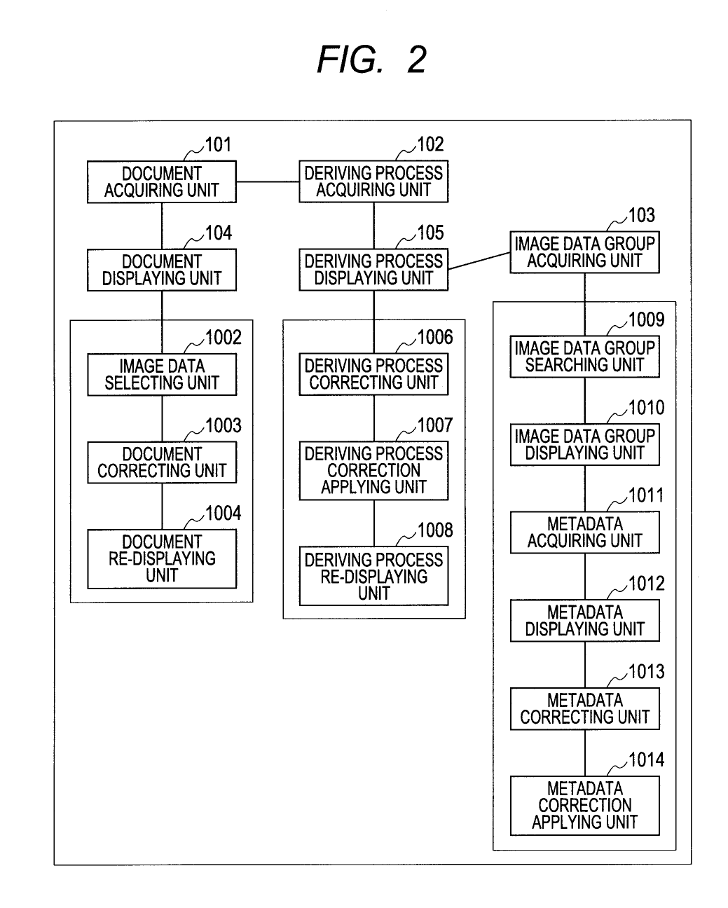

FIG. 2 is a block diagram illustrating an example of functional configuration of the document processing apparatus.

A document acquiring unit 101 acquires a personal document from each record. The document acquiring unit 101 acquires the personal document whose Variable data field has image data pasted. A document displaying unit 104 displays the personal document acquired by the document acquiring unit 101 on the display device 1801.

The document displaying unit 104 has an image data selecting unit 1002, a document correcting unit 1003, and a document re-displaying unit 1004.

An image data selecting unit 1002 accepts image data selection by an editor (user) through the input device 1802 and the UI device 1805 and makes the selected image data operable state. Hereinafter, this state will be called ‘selected state’. Details of the processing at the document correcting unit 1003 and the document re-displaying unit 1004 will be described later.

A deriving process acquiring unit 102 acquires deriving processes of the image data in the selected state. Here, ‘the deriving processes’ means conditions including combined condition for pasting data on the Variable data field in the personal document, indicating the keyword for identifying a record, the creation rule added to the Variable data field of the personal document, and the like.

A deriving process displaying unit 105 displays the deriving processes acquired by the deriving process acquiring unit 102 on the display device 1801. The deriving process displaying unit 105 has a deriving process correcting unit 1006, a deriving process correction applying unit 1007, and a deriving process re-displaying unit 1008. Details of the processing by each unit will be described later.

An image data group acquiring unit 103 acquires an image data group from the image database and, for example, displays the acquired image data group on the display device 1801. As described later, it may be adopted that the image data group acquiring unit 103 displays the acquired image data group and/or metadata on the display device 1801 in response to a request or the like from the deriving process displaying unit 105. Hereinafter, the above case will be expressed as ‘the deriving process displaying unit 105 displays the image data group’ instead of ‘the image data group displaying unit 1010 displays the image data group’. Also, it will be expressed as ‘the deriving process displaying unit 105 displays the metadata’ instead of ‘the metadata displaying unit 1012 displays the metadata’. The image data group acquiring unit 103 has an image data group searching unit 1009, an image data group displaying unit 1010, a metadata acquiring unit 1011, a metadata displaying unit 1012, a metadata correcting unit 1013, and a metadata correction applying unit 1014.

The image data group searching unit 1009 searches the image database using the metadata. The image data group displaying unit 1010 displays the image data group acquired as a result of the searching by the image data group searching unit 1009 on the display device 1801. The metadata acquiring unit 1011 acquires the metadata added to a piece of image data in the image data group displayed on the image data group displaying unit 1010, from the image database. The metadata displaying unit 1012 displays the metadata acquired by the metadata acquiring unit 1011 from the image database on the display device 1801. The metadata correcting unit 1013 accepts correction of a part of metadata displayed on the metadata displaying unit 1012 based on the user operation or the like. The metadata correction applying unit 1014 applies the correction accepted by the metadata correcting unit 1013 to the metadata of a piece of image data in the image database.

Although it is not shown in FIG. 2, the document processing apparatus may be adopted to have a personal document creating unit for creating a personal document like one described above. Also, the document acquiring unit 101 may be adopted to acquire a personal document created by the personal document creating unit.

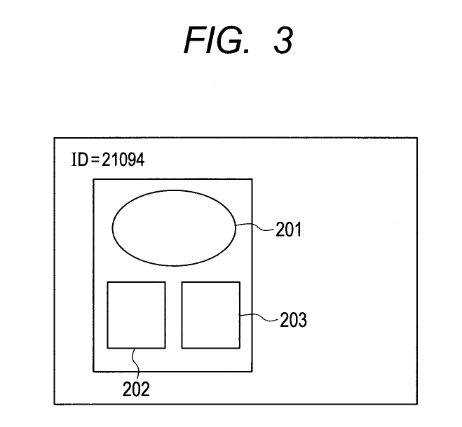

FIG. 3 is a diagram illustrating an example of personal document displayed by the document displaying unit 104. The personal document shown in FIG. 3 is a personal document of the record of personal data ID (student number) 21094. Frames 201, 202 and 203 are a part in a Variable data field on which image data is pasted or a Fixed data field. FIG. 3 is the personal document of the student number 21094; therefore, image data (or text) identified for the student number 21094 is pasted on the frame. The image data selecting unit 1002 accepts data selection for the frame of the personal document by the editor from the input device 1802, and acquires the data for the frame of the personal document. If the selected state data is the image data for the Variable data field, the deriving process displaying unit 105 displays the deriving processes for the frame data on the display device 1801. If the selected state data of the frame is the image data for the fixed data field, the deriving process displaying unit 105 does not display anything.

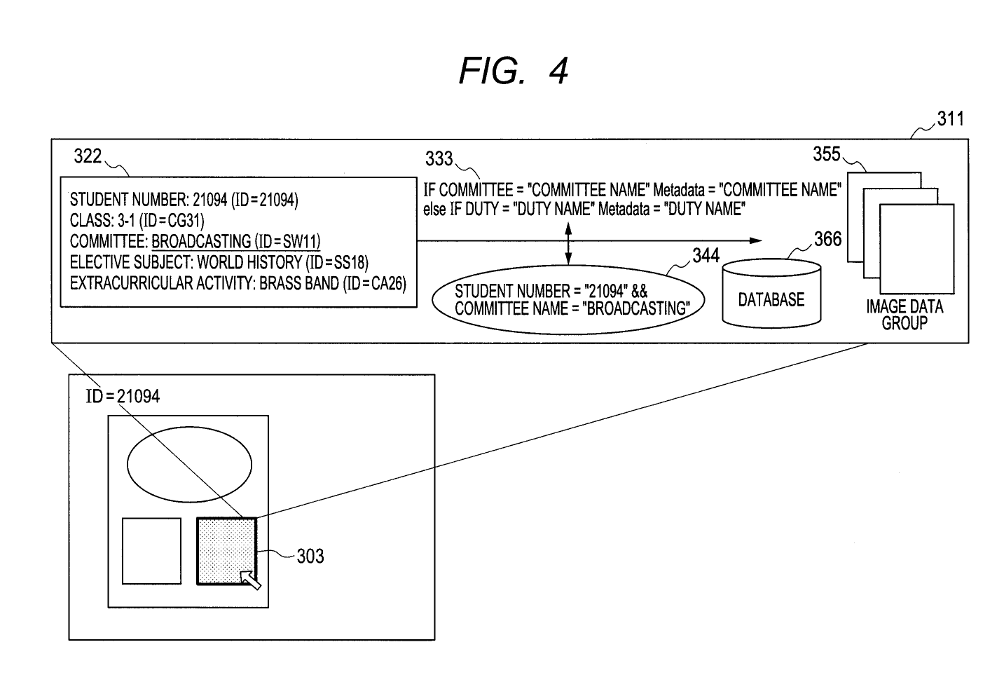

FIG. 4 is a diagram illustrating an example of deriving processes displayed by the deriving process displaying unit. The image data selecting unit 1002 turns the image data in a frame 303 to the selected state. If the image data in the frame 303 is pasted on the Variable data field, the deriving process displaying unit 105 displays the deriving processes of the above-mentioned selected state image data on the display device 1801. The deriving process displaying unit 105 searches the image database for the image data pasted on the frame by using the personal data of the record, the creation rule added to the frame, and metadata for identifying the image data, and identifies the image data.

The deriving process displaying unit 105 displays personal data 322 of the corresponding record, a creation rule 333, metadata 344, and an image data group 355, which were used for pasting the image data on the frame 303, on the display device 1801. The metadata 344 is used for searching the image database and identifying the image data to be pasted on the personal data. The image data group 355 is image data which can be acquired by searching the image database by using the metadata 344.

Hereinafter, various types of data needed for creating the personal document will be described.

The personal data 322 contains information for identifying an individual of each record. In the embodiment, it is assumed that the personal data 322 contains items of the student number, the class, the committee, the elective subject, the extracurricular activity, and the like in the school. An administrator or the like preferably registers the character codes used for the personal data such as “student number” and “class” in advance and uses the same character codes for the creation rule of the document template and the metadata of the image data stored in the image database 366 so as to facilitate the search. The deriving process displaying unit 105 may display all information in the personal data 322 or only the information necessary for deriving the selected state image data. The personal data may be the character code, or may be data uniquely determined by internally allocating ID like the parenthesized numbers instead of the character code. If the personal data information is uniquely determined by ID, the document processing apparatus manages the creation rule to add the frame of the document template and the metadata of the image data by ID allocated to each item of the personal data.

The creation rule 333 is added to each frame containing the Variable data field in the document template. The creation rule 333 is described in the document template and stored in the HDD 1808 or the like. With the creation rule 333 for identifying the image data being set in the frame, link is made with the image database so that corresponding image data can be pasted for each record to make a personal document. The creation rule 333 is a formula for indicating what type of image data is pasted on the frame. In the case of FIG. 4, the creation rule 333 ‘IF committee=“committee name” MetaData=“committee name”’ is allocated to the frame 303. This creation rule means to obtain ‘committee: committee name’ from the personal data of each record, search the image database 366 for image data with the metadata of the committee name obtained from the personal data added, and paste the image data on the frame. As in this case, if the item specified in the personal data (in this case ‘committee’) may possibly be not found, another condition can be added by using ‘else IF’ like ‘else IF duty=“duty name” Metadata=“duty name”’.

An image database 366 stores image data of a plurality of persons taken at a plurality of situation events which is to be used in creating the document template. The image database 366 is stored in the HDD 1808 or the like. In the embodiment, it is assumed that the image data including photographs of graduating student of a certain year and teachers are stored. The metadata associated with an individual and an event is embedded in each image data stored in the image database 366.

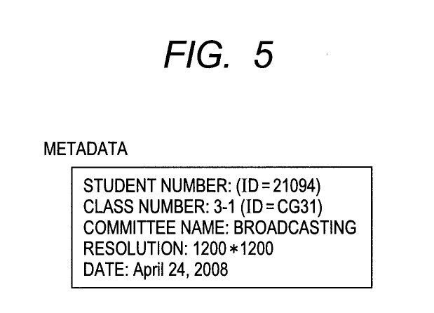

FIG. 5 is a diagram illustrating an example of metadata. The embedded metadata is preferably the character codes used in the personal data and the creation rule (or ID number allocated to each item). If the resolution, the photographed period, the feature of the image data (for example, a lot of people, landscape, or the like) are included in the metadata, detailed setting of the creation rule can be performed, and further, search of the narrowed down image data group can be performed.

The image data group acquiring unit 103 searches the image database 366 and displays the image data group 355 which match the metadata 344 with thumbnails view or the like. In displaying the image data group 355, the image data group acquiring unit 103 displays the image data in the order of the degree of how it matches the condition. The image data displayed at the top of the image data group 355 is to be practically pasted on the frame.

The deriving process displaying unit 105 acquires the creation rule added to the personal data and the frame, and the metadata 344 for searching the image database. The personal data, the creation rule, and the metadata used for identifying the content are collectively called the deriving process. Then, the deriving process displaying unit 105 displays all the image data groups that match the above-mentioned metadata 344 and the above-mentioned deriving process on the display device 1801. Also, by accepting the selection of a piece of image data among the image data group, the deriving process displaying unit 105 acquires all metadata in the image data for which the selection is accepted from the image database and displays that.

In the case of FIG. 4, the personal data ‘student number: 21094’ and ‘committee name: broadcasting’ and the creation rule ‘IF committee=“committee name” MetaData=“committee name”’ are used in searching for the image data. Accordingly, the deriving process displaying unit 105 uses the metadata ‘student number=“21094” and committee name=“broadcasting”’ to search the image database for the image data group 355 which has the corresponding metadata, and displays the deriving process and the image data group 355 on the display device 1801.

The deriving process displaying unit 105 highlights the character code (or ID number) used in driving the image data group in displaying the personal data, the creation rule and the metadata. In the case of FIG. 4, the image data in the selected state frame 303 is pasted by using ‘committee=“committee name”’ of the record. Therefore, the deriving process displaying unit 105 highlights the personal data ‘committee name: “broadcasting”’, the creation rule ‘committee=“committee name”’, and the metadata ‘committee name=“broadcasting”’. Here, the bold type is used for highlighting the data, but any type of highlighting may be used such as change the color of the letters, if only they are visually recognized.

The deriving process displaying unit 105 can visually indicate the deriving process of the selected state image data to the user by displaying the deriving process. The deriving process displaying unit 105 highlights the data as mentioned above; therefore, if the selected state image data is wrong, the user can easily identify the deriving process which causes the error.

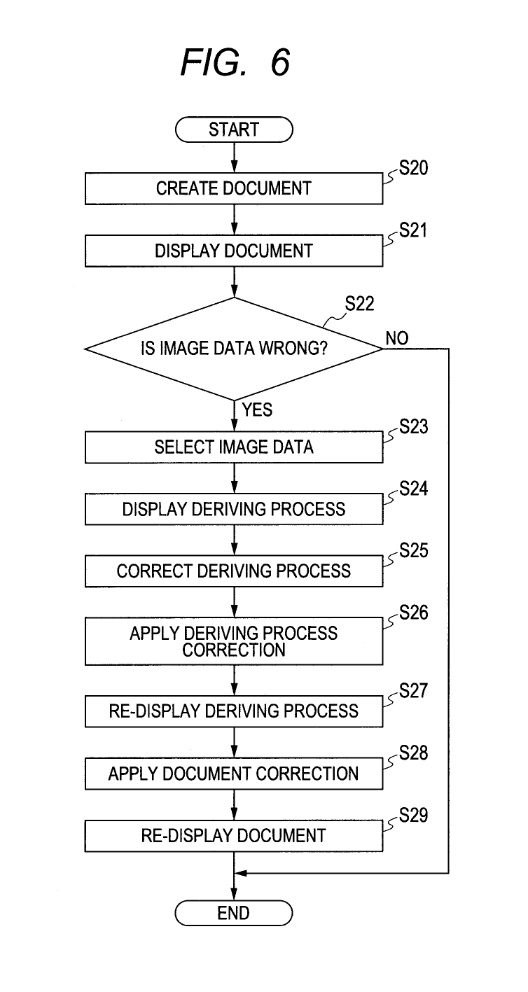

FIG. 6 is a flowchart showing an example of processing concerned with the correction of a personal document.

First, in step S20, the document processing apparatus creates the personal document by pasting corresponding image data on each frame of the document template using the personal data, the creation rule and the image database.

In step S21, the document displaying unit 104 displays the personal document on the display device 1801. The document displaying unit 104 displays the layout and the content data pasted on the Variable data field for one record. If any problem cannot be found in particular for the personal document, the user indicates to print as it is. If anything wrong in the data pasted on the Variable data field of the personal document is found in step S22 (i.e., if the user performs a certain operation for correcting the data), the operation proceeds to step S23.

In step S23, the image data selecting unit 1002 accepts selection from the user, identifies the image data in the Variable data field of the personal document concerned with the correction, and turns the image data to the selected state.

Next in step S24, the deriving process acquiring unit 102 acquires the deriving process of the selected state image data. The deriving process displaying unit 105 displays the deriving process acquired by the deriving process acquiring unit 102 on the display device 1801.

Next in step S25, the deriving process correcting unit 1006 corrects the deriving process by changing the displayed items of the deriving process based on the editor's input. More specifically, the deriving process correcting unit 1006 accepts the correction of any wrong part in the personal data, the creation rule added to the Variable data field, or the metadata of the image data which is displayed on the display device 1801. The correction of the deriving process performed by the deriving process correcting unit 1006 is the correction on the screen on the display device 1801.

Next in step S26, the deriving process correction applying unit 1007 applies the correction in step S25 to the real data to reflect the correction to the deriving process, while searching the image database by using the changed metadata again to acquire the image data group again.

Next in step S27, the deriving process re-displaying unit 1008 re-displays the corrected deriving process. More specifically, the deriving process re-displaying unit 1008 re-displays the image data group re-acquired by the deriving process correction applying unit 1007, and the correction result of the deriving process by the deriving process correcting unit 1006 on the display device 1801.

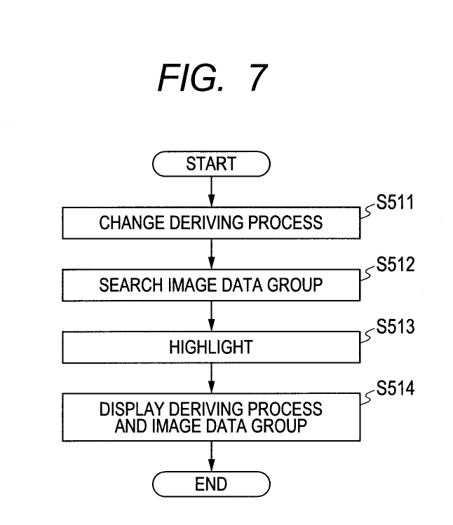

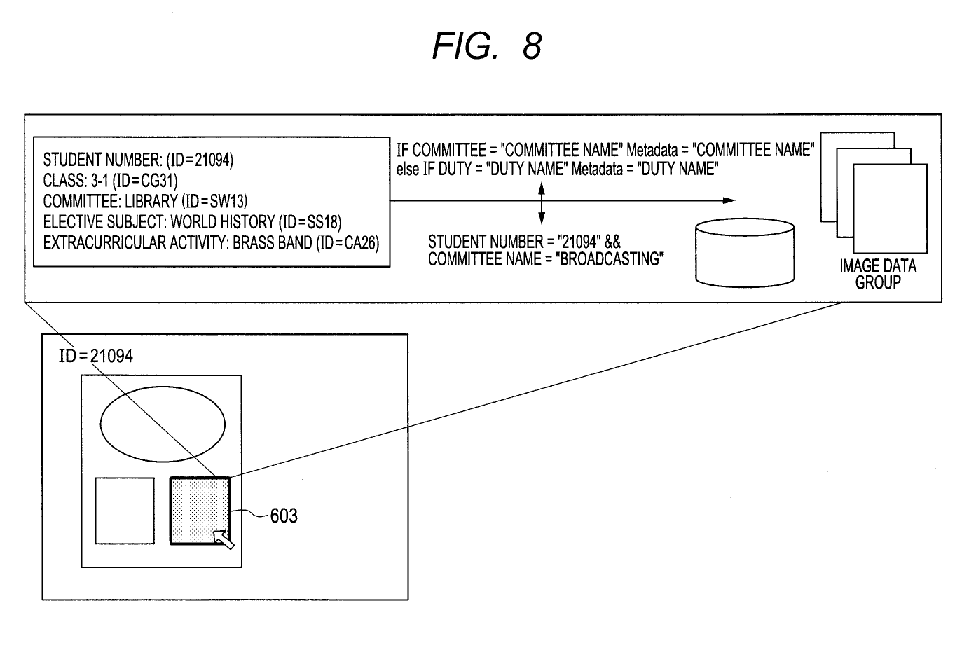

An example of the processing from step S25 to step S27 will be described later with reference to FIG. 7 and the like. And an example of the processing from step S23 to step S26 will be described later with reference to FIG. 8 and the like.

Next in step S28, the document correcting unit 1003 creates the personal document again (for example, change or the like of the image data) based on the corrected deriving process. Also, the document correcting unit 1003 examines whether the corrected result of the deriving process affects image data other than the image data of the selected state frame or not. As a result of examination, if it is determined that the other frame is also changed, the document correcting unit 1003 also performs change or the like on the image data for the frame other than selected state frame.

Finally in step S29, the document re-displaying unit 1004 displays the personal document to which change (or re-creation) or the like was performed in step S28 on the display device 1801.

FIG. 7 is a flowchart showing an example of change of the deriving process and highlight processing on the deriving process concerned with the change.

In step S511, the deriving process correcting unit 1006 accepts correction based on the input of the editor, and changes (or corrects) at least one of the personal data, the creation rule, and the metadata for searching the image database. In the description of FIG. 7, it is assumed that the metadata is changed: In step S512, the deriving process correcting unit 1006 searches for the image data group in the image database by using the metadata changed in step S511.

Next in step S513, the deriving process re-displaying unit 1008 highlights the part concerned with the correction in the deriving process.

Finally in step S514, the deriving process re-displaying unit 1008 displays the deriving process corrected by the deriving process correcting unit 1006, and the image data group acquired as a result of the search in step S512 on the display device 1801.

FIG. 8 is a diagram illustrating an example of correction on the deriving process. In the case of FIG. 8, it is assumed that a frame 603 is wrong. The image data selecting unit 1002 accepts selection from the user, identifies the image data in the Variable data field of the personal document concerned with the correction, and turns the image data to the selected state. The deriving process acquiring unit 102 acquires the deriving process of the selected state image data. Then, the deriving process displaying unit 105 displays the deriving process acquired by the deriving process acquiring unit 102 on the display device 1801. A student of the student number 21094 is a member of the library committee, but the term of the committee of the personal data is described ‘broadcasting’ in FIG. 8. The deriving process correcting unit 1006 accepts the correction of the personal data based on the user's operation, and changes ‘committee: “broadcasting”’ in the personal data to ‘committee: “library”’. In FIG. 8, the deriving process correcting unit 1006 only corrects the character code displayed on the display device 1801; therefore, at this moment, the metadata and the image data group to be used in searching the image database remains the same as those at ‘committee name =“broadcasting”’.

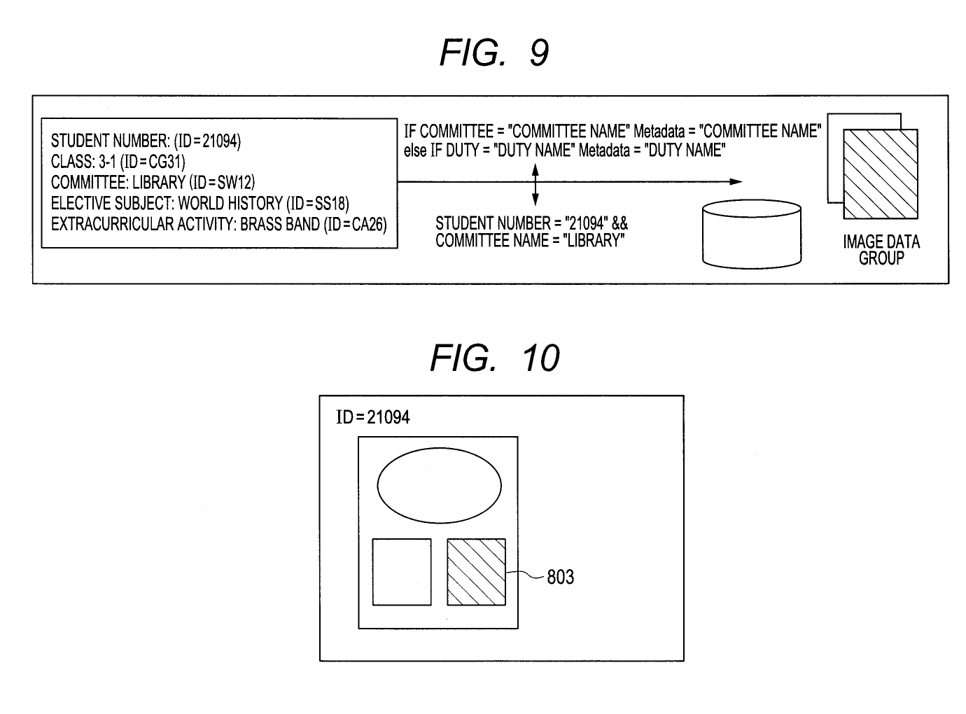

FIG. 9 is a diagram illustrating an example of application of a corrected deriving process.

The deriving process correction applying unit 1007 applies the correction of the personal data in FIG. 8 to the real data. First, the deriving process correction applying unit 1007 changes the metadata used for searching the image database from ‘student number=“21094” and committee name=“broadcasting”’ to ‘student number=“21094” and committee name=“library”’. Next, the deriving process correction applying unit 1007 (or the image data group acquiring unit 103) searches out the image data group which has the above-mentioned metadata from the image database and acquires it. The deriving process re-displaying unit 1008 displays the image data group acquired by the deriving process correction applying unit 1007 (or the image data group acquiring unit 103) on the display device 1801. Also, the deriving process re-displaying unit 1008 decides the parts to be highlighted as the personal data ‘committee name: library’, the creation rule ‘committee=“committee name”’ and the metadata ‘committee name=“library”’.

FIG. 10 is a diagram illustrating an example of a corrected personal document. The document correcting unit 1003 pastes the image data displayed at the top of the image data group in the deriving process displayed anew to the place of the image data in the selected state frame. Further, the document correcting unit 1003 searches for an item to be changed in association with the correction of the personal data, also for the frames other than a frame 803 which is in the selected state in FIG. 9. As a result of searching, if change is required, the document correcting unit 1003 specifies the metadata to be used in searching the image database based on the corrected personal data and the creation rule. Then, the document correcting unit 1003 searches out the image data group which has the specified metadata from the image database, and pastes the optimal image data to the frame. The document re-displaying unit 1004 re-displays the personal document with the corrected image data pasted on each frame.

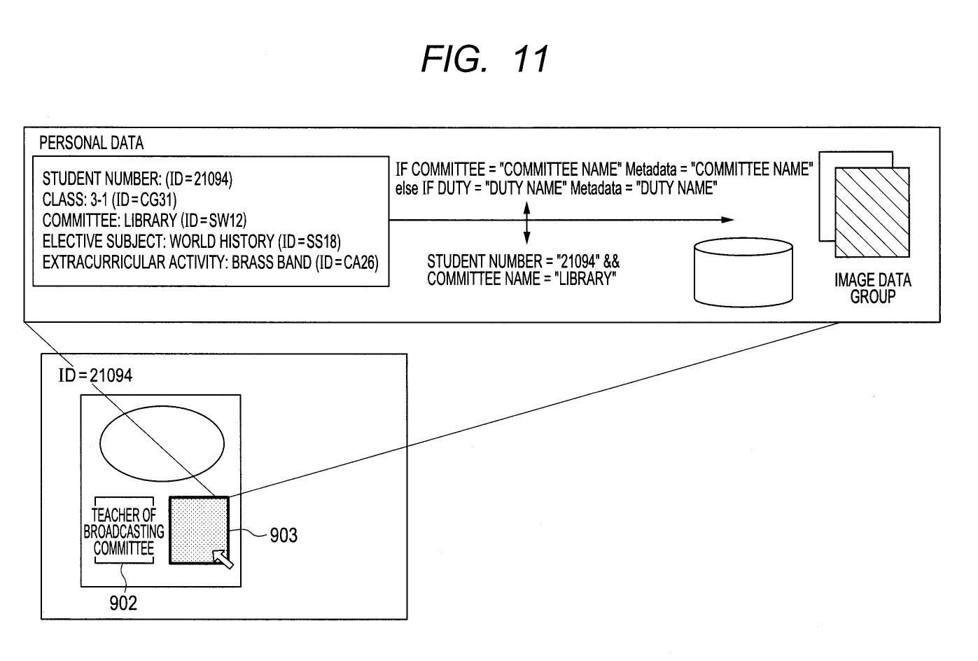

FIG. 11 is a diagram illustrating processing when image data other than that for a selected state frame is wrongly attached for the same reason. The frame 903 in FIG. 11 has the creation rule ‘committee=“committee name”’. On the other hand, the frame 902 has the creation rule ‘concerning the committee=“teacher of the committee”’. The metadata to be used in searching the image database of the image data to be pasted on the frame 903 is ‘student number=“21094” and committee name=“broadcasting”’ according to personal data 911 and creation rule 922. The metadata for searching the image data to be pasted on the frame 902 is ‘student number=“21094” and concerning the committee=“teacher of the broadcasting committee”’ according to the personal data 911 and the creation rule 922.

In FIG. 11, the image data selecting unit 1002 turns the image data in the frame 903 to the selected state based on the user operation. Then, the deriving process displaying unit 105 displays the deriving process of the selected state frame 903 on the display device 1801. If the ‘committee: committee name’ setting in the personal data is wrong, the deriving process correcting unit 1006 accepts the correction of the personal data and changes the committee in the personal data from “broadcasting” to “library” based on the user's operation. The deriving process correction applying unit 1007 changes the metadata for searching the image data of the frame 903 from ‘student number=“21094” and committee name =“broadcasting”’ to ‘student number=“21094” and committee name=“library”. Then, the deriving process correction applying unit 1007 searches out the image data group from the image database by using the changed metadata. The deriving process re-displaying unit 1008 re-displays the image data group acquired by the search on the display device 1801. The deriving process correction applying unit 1007 and the deriving process re-displaying unit 1008 keep the creation rule of the frame 902 which is not in the selected state as ‘student number=“21094” and concerning the committee=“teacher of the broadcasting committee”’.

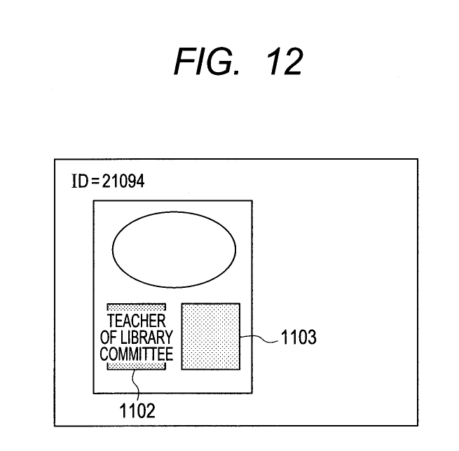

FIG. 12 is a diagram illustrating processing when personal data change is reflected on the other frames. The frames 1102 and 1103 in FIG. 12 correspond to 902 and 903 in FIG. 11. The document correcting unit 1003 changes the metadata for searching the image database of the frame 1102 from ‘student number=“21094” and concerning the committee=“teacher of the broadcasting committee”’ to ‘student number=“21094” and concerning the committee=“teacher of the library committee”’. The document correcting unit 1003 searches out the image data group to be pasted on the frame 1102 from the image database by using the changed metadata, and pastes it on the frame 1102. The document re-displaying unit 1004 re-displays the personal document whose two pieces of image data of the frames 1103 and 1102 is corrected at a time on the display device 1801.

As mentioned above, the document correcting unit 1003 reflects the correction of the deriving process for the image data of the selected state frame on the other frames which are not in the selected state. Accordingly, even if a plurality of pieces of the image data is wrong from the same origin, it is not required to turn each frame to the selected state and correct each of them, which improves the efficiency of the correction.

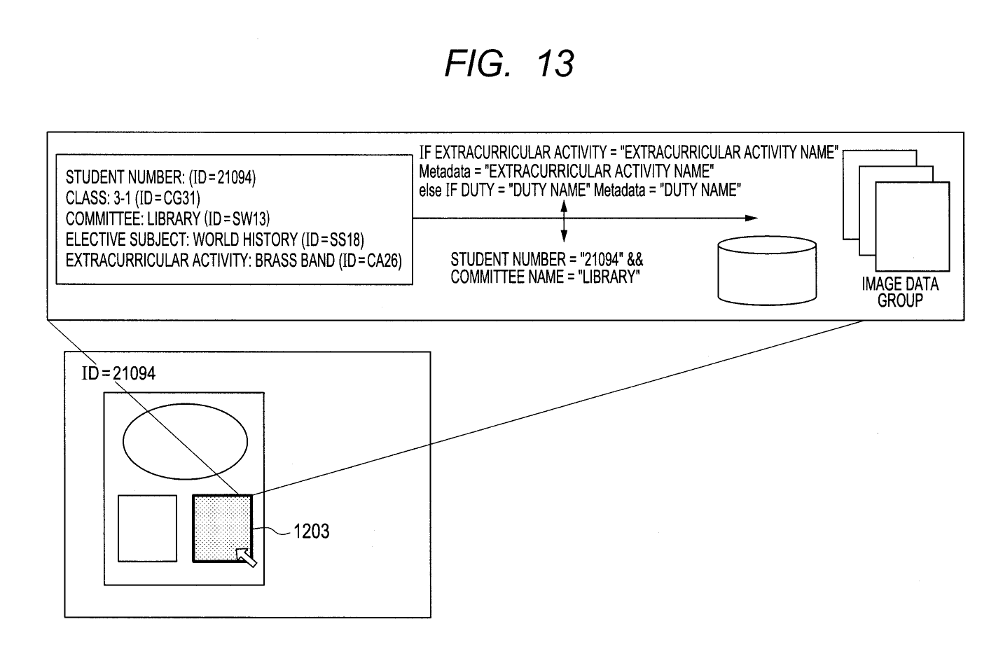

FIG. 13 is a diagram illustrating an example of creation rule correction. In FIG. 13, the creation rule added to a selected state frame 1203 is ‘committee=“committee name”’. Here, it is assumed that the layout is changed to have the image data of “the extracurricular activity”, instead of the image data of “committee”, pasted on the frame 1203. In this case, the deriving process correcting unit 1006 corrects the creation rule from that for pasting the image data “committee” to that for pasting the image data “extracurricular activity” as shown in FIG. 13 based on the user's operation. That is, the deriving process correcting unit 1006 corrects the creation rule to ‘IF extracurricular activity=“extracurricular activity name” Metadata=“extracurricular activity name”’. The corrected creation rule means obtaining the extracurricular activity name of the item ‘extracurricular activity’ from the personal data, obtaining the image data which has the metadata of the same extracurricular activity name from the image database, and pasting them to the frame 1203.

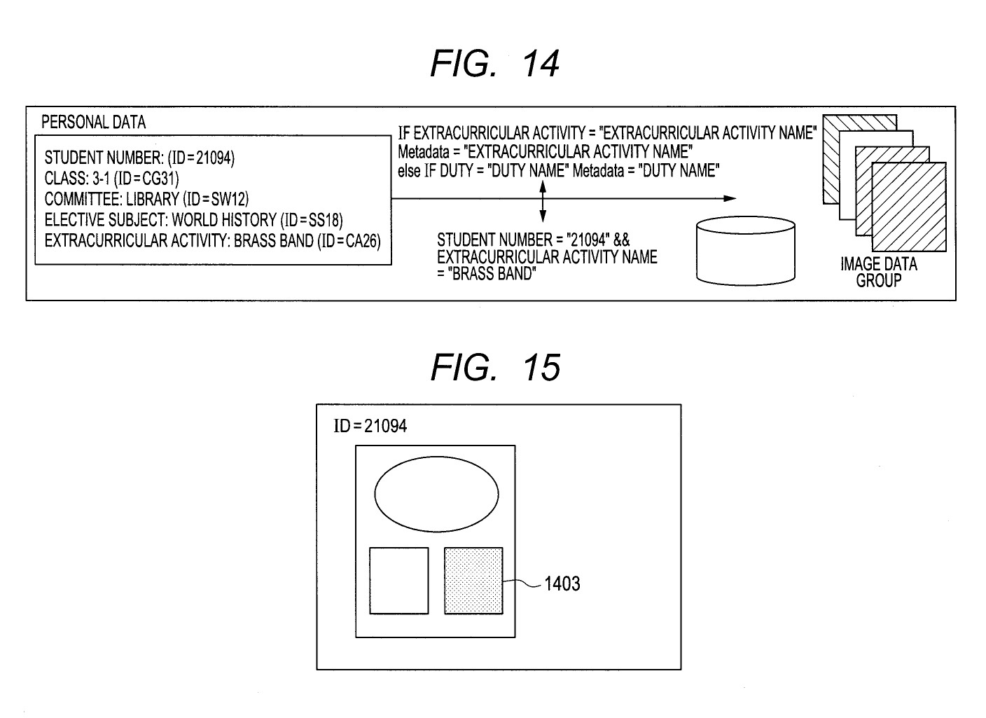

FIG. 14 is a diagram illustrating an example of application of the corrected creation rule.

The deriving process correction applying unit 1007 specifies the metadata for searching the image database anew based on the personal data and the corrected creation rule. The metadata is corrected from ‘student number=21094 and committee name=“broadcasting”’ to ‘student number=21094 and extracurricular activity name=“brass band”’. The deriving process correction applying unit 1007 searches out the image data group from the image database by using the changed metadata.

The deriving process re-displaying unit 1008 displays the changed deriving process and the image data group acquired by searching again on the display device 1801. Here, the deriving process re-displaying unit 1008 changes the item to be highlighted in association with the change of the creation rule. In the case of FIG. 14, the deriving process re-displaying unit 1008 changes the part of the personal data to be highlighted from ‘committee: committee name’ to ‘extracurricular activity: extracurricular activity name’. The deriving process re-displaying unit 1008 changes the highlight part of the creation rule to ‘extracurricular activity=“extracurricular activity name”’ and changes the highlight part of the metadata to ‘extracurricular activity=“brass band”’.

FIG. 15 is a diagram illustrating processing when creation rule change is reflected on the other frames. The document correcting unit 1003 replaces the image data in a frame 1403 displayed on the display device 1801 ‘committee name=“broadcasting”’ by ‘extracurricular activity name=“brass band”’. The document re-displaying unit 1004 re-displays the replaced personal document on the display device 1801. The creation rule of the frame is also applied to the personal documents of the other records, too. That is, the document processing apparatus can perform the change not only on the document of ‘student number=21094’ but also the frames of the same image data in the documents in the records of the other student numbers. Accordingly, it is not required to correct the data for the documents in the records of the other student numbers one by one, which improves the efficiency of the correction.

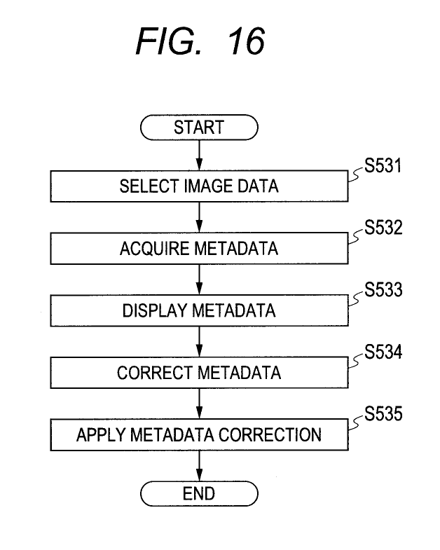

FIG. 16 is a flowchart illustrating an example of processing concerned with the correction of metadata.

If the metadata of the image data group is wrong, in step S531, the metadata acquiring unit 1011 acquires the real data of a piece of image data selected from the image data group based on the input from the editor, from the image database. As a result, the metadata acquiring unit 1011 acquires the metadata added to the image data (step S532). Next, the metadata displaying unit 1012 displays the acquired metadata. The metadata displaying unit 1012 may display the metadata on the display device 1801 in a window other than that displaying the selected state image data, or superimpose the metadata on the selected state image data.

Next, in step S533, the metadata correcting unit 1013 corrects the metadata of the selected state image data by receiving the editor's correction input. Next, in step S534, the metadata correcting unit 1013 corrects the metadata of the image data in the image database which corresponds to the selected state image data.

The processing in each step of FIG. 16 may be executed by the deriving process correcting unit 1006 or the like.

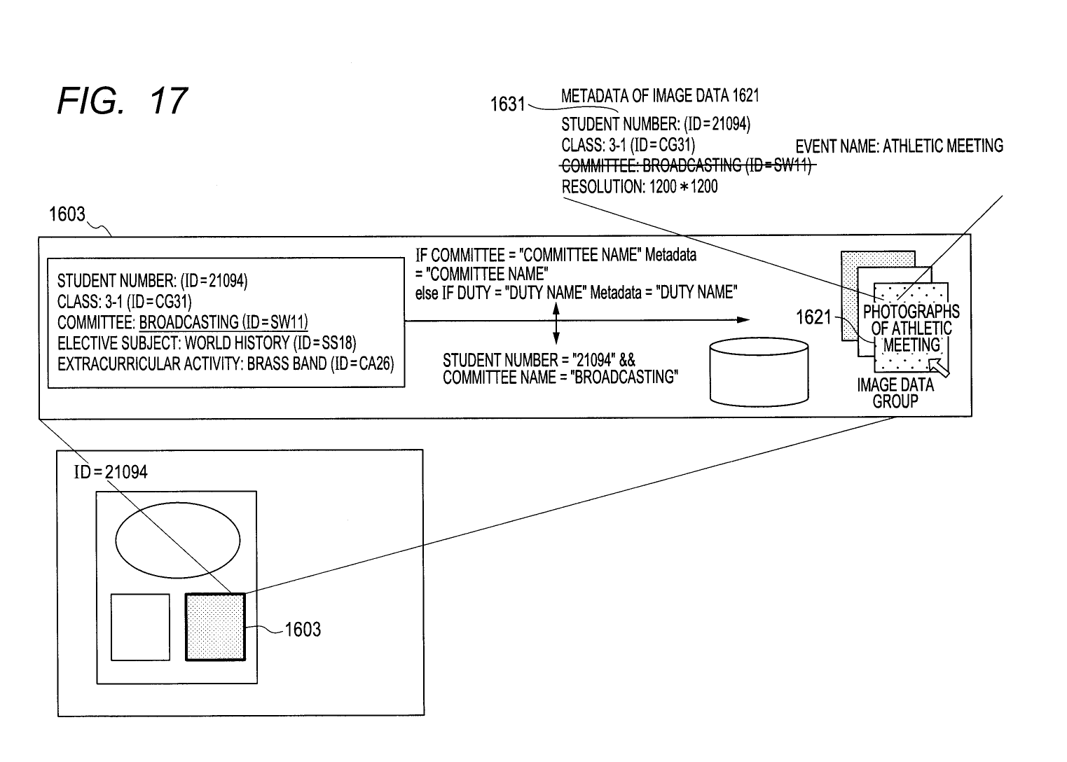

FIG. 17 is a diagram illustrating an example of metadata correction. The image data selecting unit 1002 turns the image data in a frame 1603 to the selected state. Then, the deriving process displaying unit 105 displays the deriving process as shown in FIG. 17 on the display device 1801. In the case of FIG. 17, the creation rule of the frame 1603 is set to paste the image data of a member of the broadcasting committee.

If the image data group shown in FIG. 17 includes the image data of an athletic meet of 1621, it is expected that the image data of 1621 is “athletic meeting” but contains the metadata of “broadcasting”. When the user selects the image data 1621 of the image data group, the metadata displaying unit 1012 displays the metadata of the selected state image data (1631). The metadata correcting unit 1013 accepts the correction of the metadata from the user's operation and changes “broadcasting” to “athletic meeting”.

Next, the metadata correction applying unit 1014 reflects the change of the metadata by the metadata correcting unit 1013 to the image database, and changes the metadata embedded in the image data in the image database. Once the metadata correction is applied, the image data with the new metadata does not match in the search with the metadata “broadcasting” but matches in the search with the metadata “athletic meeting”.

In order to search the image data of each frame anew, the document correcting unit 1003 also changes the image data of the frames, other than the frame 1603, to which the image data 1621 is pasted before the metadata correction is applied.

In the embodiment, it is assumed that the document processing apparatus processes the yearbook for graduating students of a school as the document data. The document data processed by the document processing apparatus may be any data if only the document data is created with information on the personal data, the creation rule and the image data. For example, if only the personal data is set as an individual profile like the embodiment, i.e., the document data personalized for each person, the document data may be Wedding Party Album or Travel Photo Album.

If information for identifying objects, instead of individual profile information, is set as the personal data, i.e., the document data is individualized for each object, the document data may be travel pamphlet or advertisement. For example, if the document data is applied to the travel pamphlet, the destination country or city of the travel, the area belonged, currency, language, and the like can be set for the personal data. If the document data is applied to advertisement, the shop name, address, telephone number, handling article, and the like can be set for the personal data.

As the metadata of the image data, property information of PDF file, EXIF information included in the image data taken by the digital camera, and the like can be used.

According to the embodiments, the part to be corrected can be easily determined by visualizing the cause of the wrong selection of the image data. The corrected result can be re-displayed so that correction can be automatically performed on the other frames or the other documents which are changed in association with the correction. Accordingly, the correction can be efficiently performed on the print data.

Various exemplary embodiments, features, and aspects of the present invention will now be herein described in detail below with reference to the drawings. It is to be noted that the relative arrangement of the components, the numerical expressions, and numerical values set forth in these embodiments are not intended to limit the scope of the present invention.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-121215, filed May 19, 2009, which is hereby incorporated by reference herein in its entirety.

What is claimed is:

1. A document processing apparatus, comprising:
a document displaying unit constructed to display a document created based on a creation rule of a document, personal data for each individual, and content data with metadata added;
a selecting unit constructed to select the content data from the document displayed by the document displaying unit, based on a user's operation;
a deriving process displaying unit constructed to display, as deriving process information, the creation rule, the personal data and the metadata which are referred to in using the content data selected by the selecting unit to create the document; and
a correcting unit constructed to correct the deriving process information displayed by the deriving process displaying unit, based on a user's operation.

2. The document processing apparatus according to claim 1, wherein the correcting unit corrects any of the creation rule, the personal data and the metadata displayed by the deriving process displaying unit, based on the user's operation.

3. The document processing apparatus according to claim 1, further comprising a deriving process re-displaying unit constructed to re-display the deriving process information corrected by the correcting unit.

4. The document processing apparatus according to claim 1, further comprising a document re-displaying unit constructed to display a personal document re-created based on the creation rule, the personal data, and the content data with the metadata added, corrected by the correcting unit.

5. A document processing method carried out in a document processing apparatus, the method comprising:
displaying a document created based on a creation rule of a document, personal data for each individual, and content data with metadata added;
selecting the content data from the displayed document, based on a user's operation;
displaying, as deriving process information, the creation rule, the personal data and the metadata which are referred to in using the selected content data to create the document; and
correcting the displayed deriving process information, based on a user's operation.

6. A computer-readable storage medium which stores a computer program for causing a computer to execute the method according to claim 5.
